(19) United States
(12) Patent Application Publication
(10) Pub. No.: US 2026/0113805 A1
(43) Pub. Date: Apr. 23, 2026

(54) METHODS FOR AI/ML-BASED DRX PATTERN CONFIGURATION FOR WTRU POWER SAVING

(71) Applicant: InterDigital Patent Holdings, Inc., Wilmington, DE (US)

(72) Inventors: Mohamed Amine Arfaoui, Montreal (CA); Philip Pietraski, Jericho, NY (US); Guodong Zhang, Woodbury, NY (US); Asil Koc, Verdun (CA)

(73) Assignee: InterDigital Patent Holdings, Inc., Wilmington, DE (US)

(21) Appl. No.: 18/920,569

(22) Filed: Oct. 18, 2024

(51) Int. Cl. H04W 76/28; H04L 5/00; H04W 52/02; H04W 72/21

(52) U.S. Cl. CPC H04W 76/28; H04L 5/0055; H04W 52/0219; H04W 72/21

(57) ABSTRACT

A wireless transmit/receive unit (WTRU) may receive a first configuration information indicating a discontinuous reception (DRX) pattern. The WTRU may receive a second configuration information comprising one or more of parameters associated with a DRX feedback report, a reporting condition for transmitting the DRX feedback report, and/or uplink (UL) resource configurations for carrying the DRX feedback report. The WTRU may transmit the DRX feedback report based on the reporting condition. The DRX feedback report may comprise one or more of WTRU battery state information and/or information associated with a calculation of a reward used in a reinforcement learning model (e.g. at the network to determine the DRX pattern).

### BACKGROUND

For systems using discontinuous reception (DRX) for wireless transmit/receive unit (WTRU) power saving, this invention describes methods to enable artificial intelligence/machine learning (AI/ML)-based DRX. Artificial intelligence (AI) may be broadly defined as the behavior exhibited by machines that mimic cognitive functions to sense, reason, adapt and/or act. An AI component may refer to the realization of behaviors and/or conformance to requirements by learning based on data without explicit configuration of sequence of steps of actions. Such AI component may enable learning complex behaviors difficult to specify and/or implement when using legacy methods.

Machine learning (ML) may refer to the type of algorithms that solve a problem based on learning through experience (e.g., data), without being explicitly programmed (e.g., configuring a set of rules). ML may be considered as a subset of AI. Different ML paradigms may be envisioned based on the nature of data and/or feedback available to the learning algorithm. For example, a supervised learning approach may involve learning a function that maps input to an output based on labeled training example, wherein each training example may be a pair consisting of an input and its corresponding output. In another example, an unsupervised learning approach may involve detecting patterns in the data with no pre-existing labels. In another example, a reinforcement learning approach may involve performing sequence of actions in an environment to maximize the cumulative reward. Some solutions may apply ML algorithms using a combination and/or interpolation of the above-mentioned approaches. For example, a semi-supervised learning approach may use a combination of a small amount of labeled data with a large amount of unlabeled data during training. In this regard, semi-supervised learning may fall between unsupervised learning (with no labeled training data) and supervised learning (with only labeled training data).

### SUMMARY

A wireless transmit/receive unit (WTRU) may receive a first configuration information indicating a discontinuous reception (DRX) pattern. The WTRU may receive a second configuration information comprising one or more of parameters associated with a DRX feedback report, a reporting condition for transmitting the DRX feedback report, and/or uplink (UL) resource configurations for carrying the DRX feedback report. The WTRU may transmit the DRX feedback report based on the reporting condition being satisfied. The DRX feedback report may comprise one or more of WTRU battery state information and/or information associated with a calculation of a reward used in a reinforcement learning model (e.g., at the network to determine the DRX pattern).

The DRX pattern may comprise a DRX cycle duration. One or more time windows may designate when the WTRU turns on during a DRX cycle, the duration of each time window, and/or the start of the next DRX cycle.

The network may compute the reward. The information associated with the calculation of the reward may comprise an indication of a power saving preference of the WTRU, a power profile of the WTRU, and/or an indication of an estimated time-to-recharge of the WTRU.

The network and WTRU may compute the reward (e.g., compute the reward jointly). The information associated with the calculation of the reward may comprise a set of parameters associated with a reward function.

The reporting condition for transmitting the DRX feedback report may be an event-triggered reporting condition based on a comparison of a parameter associated with a reward of a reinforcement learning model to a threshold. The reporting condition for transmitting is the DRX feedback report may be associated with time-based feedback reporting. The time-based feedback reporting may indicate periodic, aperiodic, and/or semi-persistent transmission of the DRX feedback report.

The WTRU may receive a request to transmit dynamic DRX operation capabilities. The WTRU may transmit a response message. The response message may comprise the WTRU's dynamic DRX operation capabilities.

The WTRU may receive an updated DRX pattern. The updated DRX pattern may be different than the DRX pattern indicated by the first configuration information and/or be based on the DRX feedback report.

The WTRU may transmit the DRX feedback report in a hybrid automatic repeat request (HARQ) acknowledgement/not acknowledgement (ACK/NACK) report. The WTRU may transmit the DRX feedback report in the uplink (UL) control information and/or on the physical UL control channel (PUCCH) and/or physical UL shared channel (PUSCH).

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 depicts an example diagram representing a Markov decision process.

FIG. 3 depicts an example diagram of a basic discontinuous reception (DRX) operation.

FIG. 4 depicts an example diagram of long and short DRX cycles.

FIG. 5 depicts an example diagram of dynamic DRX operation.

FIG. 6 depicts an example diagram of network and wireless transmit/receive unit (WTRU) procedures to learn a DRX pattern.

FIG. 7 depicts an example flowchart of wireless transmit/receive unit (WTRU) procedures for a dynamic DRX operation.

### DETAILED DESCRIPTION

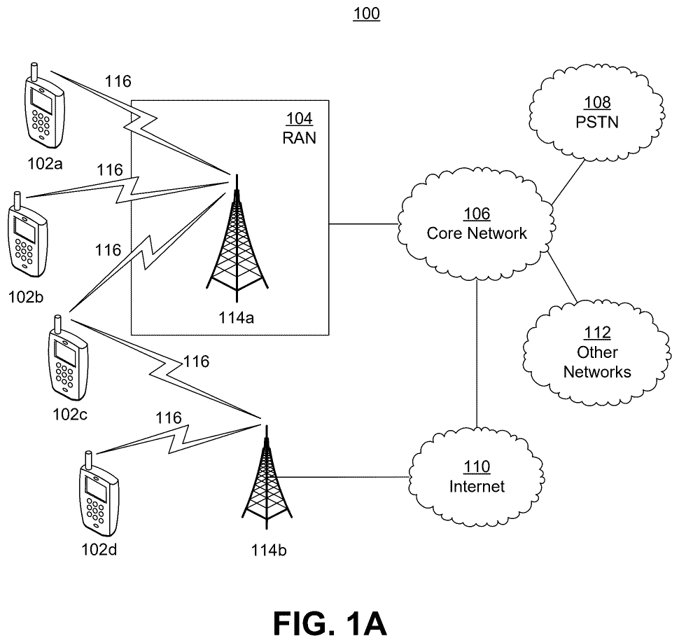

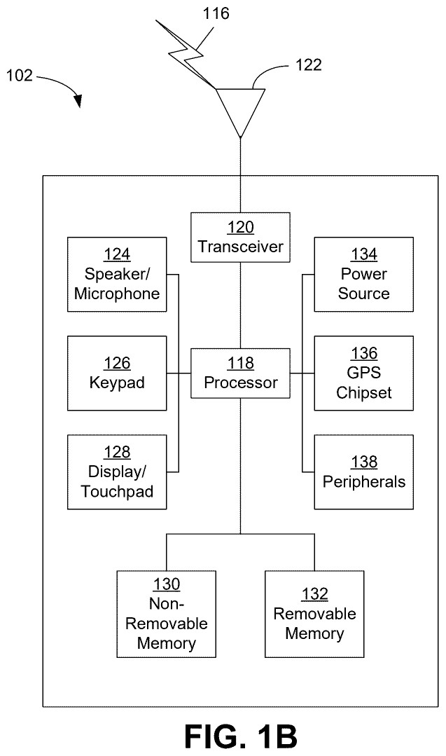

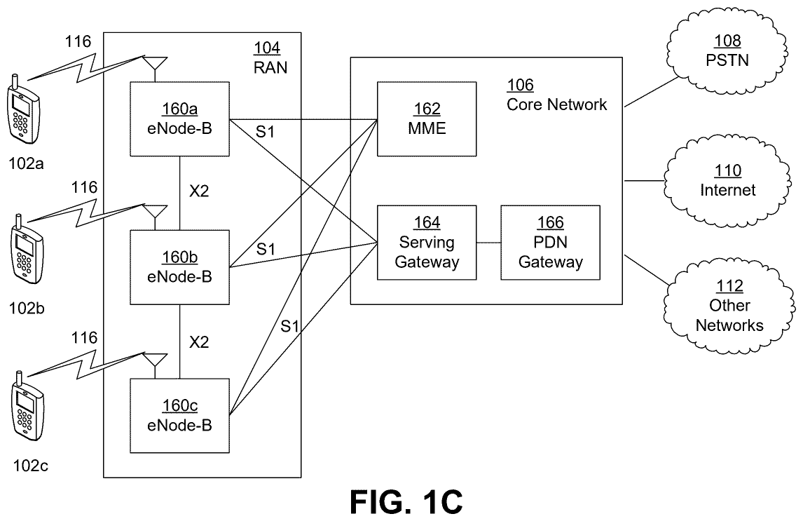

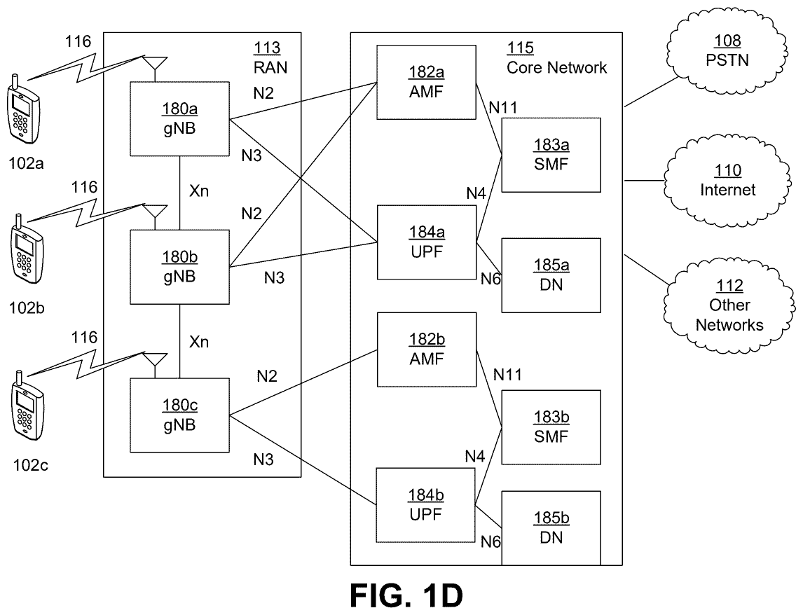

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Machine learning (ML) may refer to the type of algorithms that solve a problem based on learning through experience (e.g., data), without being explicitly programmed (e.g., configuring a set of rules). ML may be considered as a subset of AI. Different ML paradigms may be envisioned based on the nature of data and/or feedback available to the learning algorithm. For example, a supervised learning approach may involve learning a function that maps input to an output based on labeled training example, wherein each training example may be a pair consisting of an input and its corresponding output. In another example, an unsupervised learning approach may involve detecting patterns in the data with no pre-existing labels. In another example, a reinforcement learning approach may involve performing sequence of actions in an environment to maximize the cumulative reward. Some solutions may apply ML algorithms using a combination and/or interpolation of the above-mentioned approaches. For example, a semi-supervised learning approach may use a combination of a small amount of labeled data with a large amount of unlabeled data during training. In this regard, semi-supervised learning may fall between unsupervised learning (with no labeled training data) and supervised learning (with only labeled training data).

Deep learning (DL) may refer to a class of ML algorithms that employ artificial neural networks, specifically, Deep Neural Networks (DNNs). DNNs were loosely inspired from biological systems. DNNs are a special class of ML models inspired by the human brain wherein the input is linearly transformed and passes through non-linear activation function multiple times. DNNs may comprise of multiple layers. Each layer may comprise linear transformation and/or given non-linear activation functions. DNNs may be trained using the training data via back-propagation algorithm. Recently, DNNs have shown state-of-the-art performance in a variety of domains, e.g., speech, vision, natural language, wireless communication, etc., and/or for various ML settings (e.g., supervised, un-supervised, and/or semi-supervised, etc.).

Reinforcement learning (RL) is a branch of ML that focuses on decision-making by autonomous agents. An autonomous agent may represent a system capable of making independent decisions and/or responding to its surroundings without direct human intervention. By contrast to supervised and/or supervised learning, RL agents may learn to act and/or to execute tasks through trial and error, without explicit human guidance. This approach specifically tackles sequential decision-making challenges within dynamic environments.

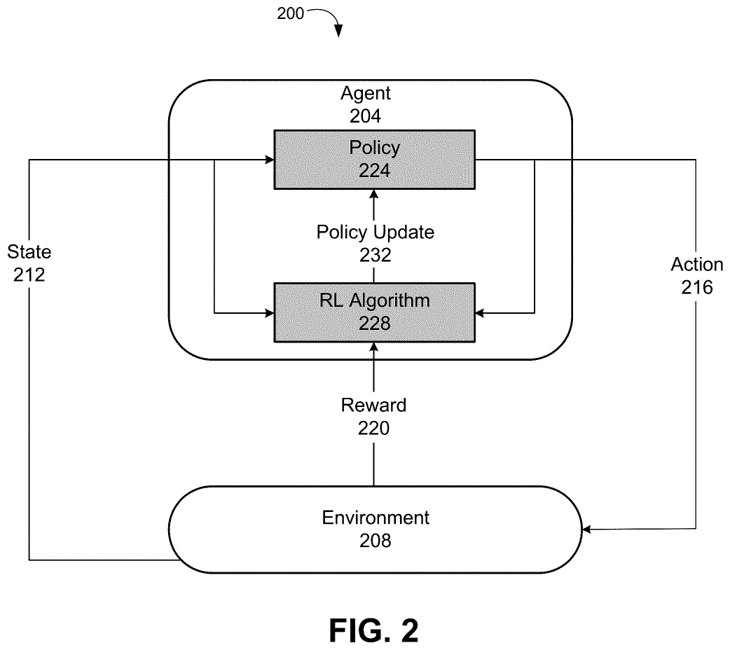

Reinforcement learning may essentially consist of the relationship between an agent, an environment, and/or a goal. As depicted in FIG. 2, this relationship is formulated in terms of the Markov decision process (MDP) 200. The reinforcement learning agent 204 may learn about a problem by interacting with its environment 208. The environment 208 may provide information on its current state 212. The agent 204 may then use that information to determine which actions to take. The decided action 216 may move the environment 208 from its current state 212 to a new state. If that action 216 obtains a positive reward signal 220 from the surrounding environment 208, the agent 204 is encouraged to take that action again when in a similar future state. This process may repeat for every new state thereafter. Over time, the agent 204 learns from rewards 220 to take actions within the environment that meet a specified goal. In MDP, state space may refer to the space of all possible states an environment's 208 might be in. In MDP, action space may refer to the space of all possible actions the agent 204 may take upon receiving a state and/or a reward 220 from the environment 208.

As depicted in FIG. 2, the agent 204 may contain two components: a policy 224 and a learning algorithm 228 (e.g., a reinforcement learning algorithm). The policy 224 may be a mapping from the current state 212 to a probability distribution of the actions 216 to be taken. Within an agent 204, the policy 224 may be implemented by a function approximator with tunable parameter(s) and/or specific approximation model(s), such as neural networks. At 232, the learning algorithm 228 may continuously update the policy parameters 228 based on the actions 216, rewards 220, and/or states 212. The goal of the learning algorithm 228 is to find an optimal policy 224 that maximizes the expected cumulative long-term reward 220.

Because an RL agent has no manually labeled input data guiding its behavior, it must explore its environment. The RL agent may attempt new actions to discover those actions that receive rewards. From these reward signals, the agent may learn to prefer actions for which it earns rewards to maximize its gain. Despite the gains from rewards, the agent must continue exploring new states and/or actions as well. The agent may use that experience of exploring new states and/or actions to improve its decision-making. RL algorithms thus require an agent to both exploit knowledge of previously rewarded state-actions and/or explore other state-actions. The agent may not exclusively pursue exploration and/or exploitation. Rather, the agent may continuously try new actions while also preferring single (or chains of) actions that produce the largest cumulative reward.

The study of wireless transmit/receive unit (WTRU) power saving in new radio (NR) may include the study of the power saving schemes and/or the associated procedures. The power saving schemes may study the WTRU adaptation to the traffic and to WTRU power consumption characteristics in frequency, time, antenna domains, DRX operation, and/or reducing PDCCH monitoring and/or decoding.

Discontinuous reception (DRX) is a power-saving mechanism that may be used in mobile communication systems to extend the battery life of WTRUs. DRX may allow WTRUs to periodically turn off their receivers and/or enter a low-power state, waking up at specific intervals to check for incoming data and/or signals. This pattern may help to reduce power consumption during periods of inactivity. 5G NR DRX may involve specific configurations and/or parameters related to discontinuous reception in the 5G NR interface. 5G NR DRX is designed to enhance the power efficiency of WTRUs by intelligently controlling when the WTRUs may activate and/or deactivate their receivers.

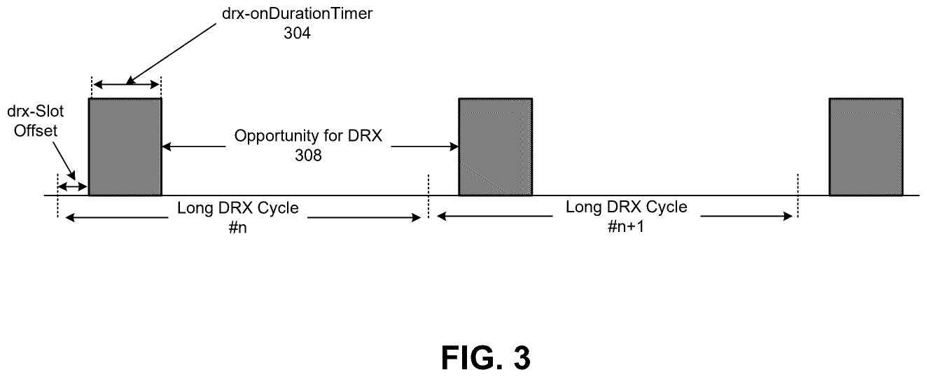

During DRX mode, the WTRU may conserve power by shutting down most of its circuitry when there's no data to receive or transmit. As shown in FIG. 3, the WTRU in this state periodically listens to the downlink physical downlink control channel (PDCCH), known as the active state or DRX ON period 304. Conversely, when the WTRU does not monitor the PDCCH, it is known as the DRX sleep state or the DRX OFF period 308.

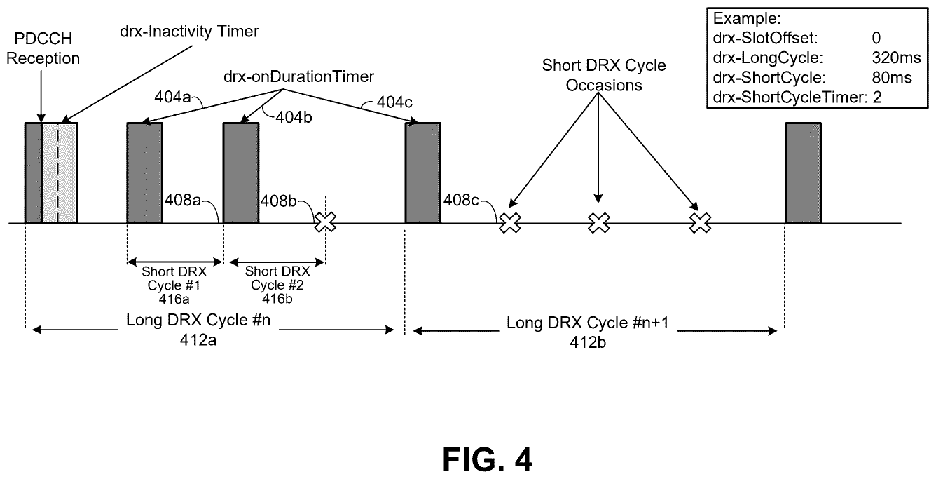

As depicted in FIG. 4, 5G NR DRX comprises several key components. One such component may include DRX cycles. The DRX cycle defines the duration for which the WTRU remains in an active state before entering a low-power state. The DRX cycle may be divided into on-duration 404a-c (e.g., active state) and/or off-duration 408a-c (e.g., low-power state).

Different DRX configurations may be defined to suit various network and/or WTRU requirements. Such requirements may include setting parameters such as DRX cycle length, on-duration, and/or off-duration.

The long DRX cycle 412a-b may refer to a DRX configuration with a long cycle duration. The long DRX cycle 412a-b may be suitable for scenarios where the device can afford to stay in a low-power state for extended periods. The short DRX cycle 416a-b may refer to a DRX configuration with a short cycle duration. The short DRX cycle 416a-b may be suitable for scenarios where the device needs to be more responsive and/or cannot afford long periods of inactivity.

Connected mode DRX (e.g., cDRX) may be a key feature for WTRU energy saving. In connected mode, the device is actively communicating with the network. In connected mode, the cDRX may allow the device to periodically switch between active and/or low-power states. The cDRX mat be particularly useful when the WTRU expects incoming data but wants to conserve power during idle periods. The cDRX may provide two levels of monitoring granularity via the long 412a-b cycle and short cycle 416a-c DRX configurations. The cDRX may allow the WTRU to monitor scheduling messages during well-defined monitoring intervals (e.g., during 10 ms on-durations once every 160 ms in long DRX). The rest of the time the WTRU may remain in sleep mode.

As mobile devices support ever growing data traffic and/or high-resolution screen time, saving WTRU battery becomes increasingly important. In the power saving scheme with WTRU adaptation to the DRX operation, the network may select one of two preconfigured ON/OFF patterns for the WTRU, referred to as the DRX patterns. The network may configure DRX patterns. Different events may further trigger DRX patterns. Different mobile applications and/or services may produce different mobile data traffic patterns. Growing types of services may imply that the number of such data patterns is also growing. The scheduler at the network may impact the traffic pattern as seen over the air. However, the limited number of possible DRX patterns does not permit adaption of the ON/OFF pattern to match the data traffic pattern.

The scheduler at the network may not take the WTRU battery status into consideration. The scheduler at the network may not consider the desired latency-energy tradeoff desired by the WTRU. From the WTRU perspective, the WTRU may have two conflicting goals in DRX operation. The WTRU may need to be OFF as long as possible to save power. However, the WTRU may need to be ON long enough, and/or on at the right time, to maintain the desired service latency requirement. Therefore, a solution that enables the network to generate dynamic DRX patterns (with assistance from the WTRU) that matches the WTRU traffic pattern, takes the WTRU battery state into consideration, and/or meets the service latency requirements, may be required.

A solution for WTRU power saving may provide dynamic and/or configurable DRX operation. Specifically, the solution may enable the network to learn DRX patterns, with the assistance of feedback from the WTRU. The network may learn the DRX patterns that better matches the WTRU traffic pattern, takes the WTRU battery state into consideration, and/or meets the service latency requirements.

As traffic patterns and/or the desired DRX patterns can be learned, AI/ML methods may be considered. The network may schedule the downlink (DL) data transmission to the WTRU during DRX cycles with configurable durations that may be either constant and/or variable. Each DRX cycle may consist of a set of time windows with configurable durations, within which the network may schedule the DL data transmission to the WTRU. Each time window may include an integer number of time slots. Simultaneously, the network may configure the ON/OFF pattern for the WTRU within each DRX cycle in a way that matches the DL data transmission scheduling pattern.

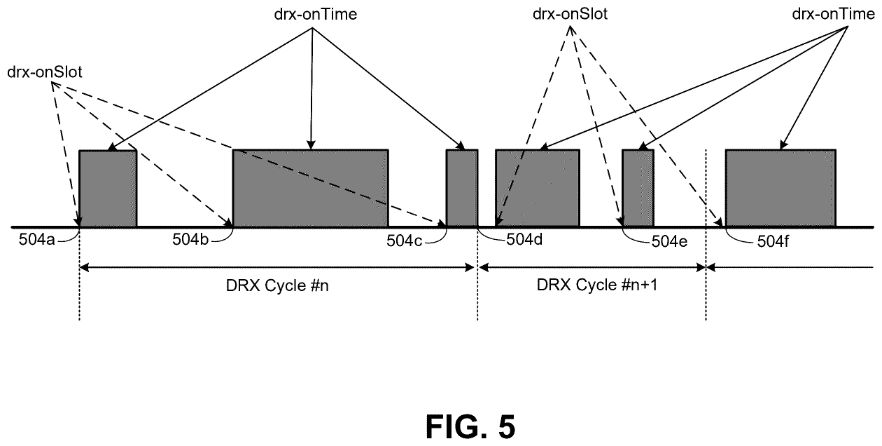

As depicted in FIG. 5, for each DRX cycle, the network may indicate to the WTRU the transmission time windows 504a-f, configured through the parameter drx-onSlot, along with the duration of each time window in time slots, configured through the parameter drx-onTime. The time slots within each time window are referred to as the ON slots. The WTRU turns ON and stays ON according to the configured drx-onSlot and/or drx-onTime parameters within each DRX cycle. A drx-cycleDuration parameter may also be sent with the DRX cycle configuration message indicating the last slot in the cycle. A drx-repetition may also be indicated. The drx-repetition may tell the WTRU how to behave until new DRX cycle parameters are received. For example, drx-repetition may indicate how many times to replicate the DRX pattern previously signaled. A drx-combine may also be indicated. The drx-combine may tell the WTRU if the indicated DRX pattern should be combined with existing DRX pattern(s) and/or should replace existing DRX pattern(s).

Such combined patterns may be useful when multiple services with different traffic patterns are required simultaneously. A drx-impliedON may also be indicated. The drx-impliedON may tell the WTRU to remain ON for the indicated number of slots following data reception in an ON Slot. A drx-impliedDC may also be indicated. The drx-impliedDC may tell the WTRU to remain ON with an indicated duty cycle for an indicated number of slots following data reception in an ON slot. For example, drx-impliedDC of 2:4:24 would indicate ON, ON, OFF, OFF, OFF, OFF pattern would repeat until 24 slots after the ON Slot in which data was received (and would be combined with any existing DRX patterns). A drx-nextDRX may also be indicated which tells the WTRU to remain OFF for the indicated number of slots between the end of DRX cycle and the beginning of the next DRX cycle.

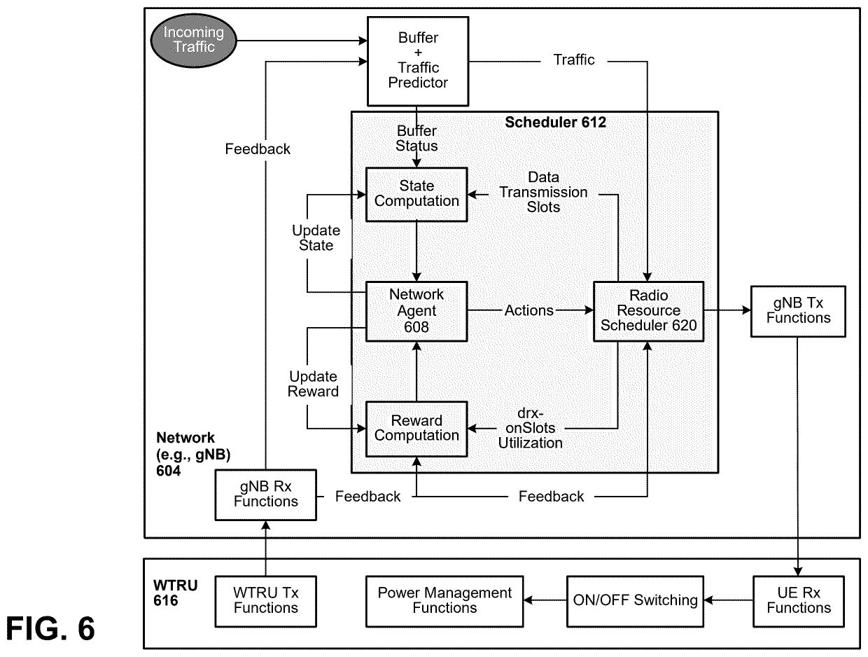

FIG. 6 depicts a diagram of network procedures to learn a DRX pattern. FIG. 6 depicts the components of the MDP of deciding the DRX patterns by the network (e.g., gNB) 604. The network agent 608 may reside at the network scheduler 612. The network agent 608 action may be the DRX pattern. The DRX pattern may be defined in terms of the parameters drx-onSlot and the drx-onTime for each drx-onSlot. The network agent 608 may configure these parameters to the WTRU 616 over each DRX cycle. Afterwards, the radio resource scheduler 620 may allocate resources for the WTRU 616 for DL data transmission over the decided ON slots. Note that DL data transmissions may be decided solely by the radio resource scheduler 620. The radio resource scheduler 620 may decide to not schedule a DL data transmission for the WTRU 616 over an ON slot that the network agent 608 decided.

In the WTRU 616 side, the WTRU 616 may receive the DRX pattern configuration from the network 604. The WTRU 616 may turn its circuit ON/OFF based on the received DRX pattern from the network 604 for each DRX cycle. Accordingly, for each time window indicated in the drx-onSlot, the WTRU 616 may stay ON for the number of slots indicated in the associated drx-onTime. Based on this, the WTRU 616 may report ACK/NACK to the network 604. The WTRU 616 may also report its battery state information to the network 604 for effective DRX pattern decisions. The battery state and/or power saving profile information reporting may be either periodic, aperiodic, and/or semipersistent. These parameters may change slowly and so need infrequent updating. The network 604 may receive the feedback from the WTRU 616, computes the reward, and determines the new state associated to the network agent 604 actions.

The network agent reward is a combination of WTRU OFF time ratio; DRX induced latency; ON slots utilization; and/or overhead penalty. WTRU OFF time ratio may be computed from the DRX pattern decided by the network agent. WTRU OFF time ratio may measure the amount of time the WTRU circuit was turned OFF. WTRU OFF time ratio may measure efficacy of the decided DRX patterns in saving the WTRU power. DRX induced latency may be estimated by monitoring how long data stays in the buffer and/or is stalled by waiting for the next ON opportunity to transmit data. ON slots utilization may be computed from the radio resource scheduler. ON slots utilization may measure how efficiently the network scheduler used the ON slots decided by the network agent to schedule DL data transmission to the WTRU. For example, ON slots utilization can be the percentage of used ON slots. Overhead penalty may be associated to transmitting the DRX pattern decided by the network agent and to transmitting the feedback report from the WTRU. An equation for the reward may be expressed as Equation (1), but other equations may exist:

$$Reward = f ( {T}_{OFF} ) + g ( {L}_{E 2 E} ) + h ( {O}_{DRX} ) , \qquad ( 1 )$$

Where T_{OFF} denotes the WTRU OFF time ratio indicated above; L_{E2E} denotes the end-to-end latency induced by: DRX induced latency indicated above, ON slots utilization indicated above, and/or HARQ process; and/or O_{DRX} denotes the overhead penalty indicated above.

Moreover, the functions ƒ, g, and/or h may map the quantities T_{OFF}, L_{E2E}, and/or O_{DRX}, respectively, to the reward. The functions ƒ, g, and/or h may be characterized as follows: the functions ƒ, g, and/or h, are configured by the network. Each one of the functions ƒ, g, and/or h can be either preconfigured and/or learnable. Each one of the functions ƒ, g, and/or h may be polynomial (e.g., linear, quadratic, etc.), rational, AI/ML model, etc. The network may fully configure the functions g, and/or h. The network may fully configure the function ƒ, and/or the network and WTRU may jointly configure the function ƒ. Specifically, the function ƒ may map the WTRU OFF time ratio T_{OFF} to the power saved by the WTRU. Therefore, the function ƒ may provide a means to include the battery state information of the WTRU, the WTRU power profile, and/or the WTRU power saving preferences, etc., in the reward.

Consequently, for the case when the network fully configures ƒ, the WTRU may report to the network its battery state information, its power profile, its power saving preferences, and/or with any other relevant information related to the WTRU power saving mechanism and the latency-energy tradeoff requirement for the WTRU. Examples of how the WTRU may compute a power saving preference includes, but may not be limited to, battery state, estimated future use of power, and/or estimated time of recharge, etc.

For the case when the network and the WTRU jointly configure the function ƒ, the WTRU may determine a set of parameters that is part of the total set of parameters of the parametric function ƒ. The set of parameters determined by the WTRU may be associated to the WTRU battery state information, the WTRU power profile, the WTRU power saving preferences, and/or with any other relevant information related to the WTRU power saving mechanism and/or the latency-energy tradeoff requirement for the WTRU. The network may signal to the WTRU the structure of the parameters (e.g., type, format, range of parameters, etc.). The WTRU may then determine the set of parameters and then report it to the network. Then, the network may compute the entire parametric function ƒ and/or then compute the rewards.

The network agent state may comprise the history of: DRX induced latency; DL data transmission slots; buffer status; and/or WTRU battery state information. The DRX induced latency may be estimated by monitoring how long data stays in the buffer and/or stalled by waiting for the next ON opportunity to transmit it. The DL data transmission slots may be obtained from the radio resource scheduler. Buffer status may update after pushing or pulling data out for DL transmission. WTRU battery state information: may include the WTRU battery state information reported from the WTRU to the network. After the network agent computes the state and/or the reward, the network agent may decide on the DRX pattern for the next DRX cycle, and the entire procedure is repeated.

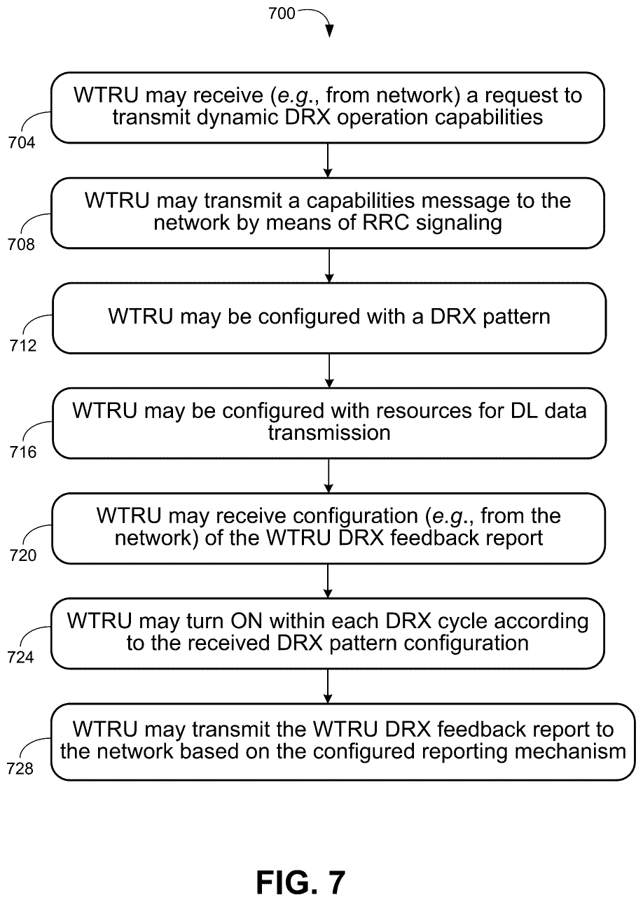

FIG. 7 depicts a flowchart 700 that details the WTRU procedures for dynamic DRX operation. The network may refer to any node in the network (e.g., gNB), and/or another WTRU (e.g., sidelink, WTRU-to-WTRU direct communication), etc. At 704, the WTRU may receive (e.g., from the network) a request to transmit dynamic DRX operation capabilities. At 708, the WTRU may transmit its capabilities to the network by means of RRC signaling. The WTRU may transmit a capabilities message indicating WTRU support for dynamic DRX operation.

At 712, the WTRU is configured with a DRX pattern. The DRX pattern may include: the DRX cycle duration drx-cycleDuration. If not included, the last ON slot may imply the end of the cycle. The DRX pattern may include the time windows, which include the ON Slots within the DRX cycle, defined with the parameter drx-onSlot. The DRX pattern may include the duration of each time window in time slots, defined by the parameter drx-onTime. The DRX pattern may include other parameters, such as drx-repetition, drx-combine, drx-impliedON, drx-impliedDC, drx-nextDRX, etc. The DRX pattern may include the start of the next DRX cycle. The initial DRX pattern may be generated from legacy DRX patterns. The WTRU may receive the DRX pattern configuration at the beginning of each DRX cycle. The WTRU may receive the DRX pattern configuration dynamically (e.g., through DCI and/or MAC-CE).

At 716, the WTRU may be configured with resources for DL data transmission. The radio resources may occur during any ON slot in each DRX cycle. The WTRU may receive the radio resource allocations dynamically (e.g., through DCI and/or MAC-CE).

At 720, the WTRU may receive configuration (e.g., from the network) of the WTRU DRX feedback report configuration. The WTRU DRX feedback report configuration may include one or more of the messages and/or parameters that should be included in the WTRU DRX feedback report, which include one or more of: WTRU battery state information and/or information to compute the reward of the RL-framework at the network. If the network fully computes the reward, then the WTRU DRX feedback report may include the WTRU battery state information, the WTRU power profile, the WTRU power saving preferences, and/or with any other relevant information related to the WTRU power saving mechanism and/or to the latency-energy tradeoff requirement for the WTRU. If the network and WTRU jointly compute the reward, the WTRU DRX feedback report may include a set of parameters that is part of the network reward function. Moreover, the set of parameters may be associated to the WTRU battery state information, the WTRU power profile, the WTRU power saving preferences, and/or any other relevant information related to the WTRU power saving mechanism and to the latency-energy tradeoff requirement for the WTRU. The structure of the parameters (e.g., type, format, range of parameters, etc.) may be either preconfigured and/or dynamically configured by the network.

The WTRU feedback report configuration may further include the reporting condition (e.g., triggering condition) of a transmission of the WTRU DRX feedback report. Examples may include time-based feedback reporting condition, wherein the WTRU DRX feedback report may be periodic, aperiodic, or semi-persistent. Examples may further include event-triggered feedback reporting condition wherein the WTRU may compute a certain parameter associated to the reward of the RL framework at the network. The WTRU may compare the computed parameter to some thresholds configured by the network. The WTRU may transmit the WTRU DRX feedback report if the computed parameter is lower or higher than the configured thresholds. The reporting condition of a transmission of the WTRU DRX feedback report may further include a mixture of time-based feedback reporting condition and event-triggered feedback reporting condition and/or a request from the network.

The WTRU DRX feedback report configuration may further include the signals and/or the uplink resource configuration/allocations that should carry the WTRU DRX feedback report. For example, physical uplink shared channel (PUSCH), physical uplink control channel (PUCCH), RRC, uplink control information (UCI), and/or medium access control element (MAC-CE). For example, a WTRU may report WTRU DRX feedback report in a HARQ-ACK report (e.g., appended to or multiplexed with a HARQ-ACK report). The WTRU DRX feedback report configuration may be either preconfigured, configured by means of RRC signaling, or dynamically configured (e.g., through DCI or MAC-CE).

At 724, the WTRU may turn ON within each DRX cycle according to the received DRX pattern configuration. At 728, the WTRU may transmit the WTRU DRX feedback report to the network based on the configured reporting condition. The WTRU may transmit the WTRU DRX feedback report. The WTRU may transmit the WTRU DRX feedback report in the UCI, transmitted on PUCCH and/or PUSCH.

The network may receive the WTRU DRX feedback report from the WTRU. The network may determine the state and/or the reward with the assistance of the WTRU DRX feedback report transmitted by the WTRU. The state may include, but not be limited to: history of DRX induced latency; history of DL data transmission slots; buffer status; and/or WTRU battery state information. History of DRX induced latency may be estimated by monitoring how long data stays in the buffer and/or stalled by waiting for the next ON opportunity to transmit the data. History of DL data transmission slots may be obtained from the radio resource scheduler. Buffer status may be updated after pushing and/or pulling data out for DL transmission. WTRU battery state information may be obtained from the WTRU DRX feedback report transmitted from the WTRU to the network. The reward may be a combination of: DRX induced latency; ON slots utilization; WTRU OFF time ratio; and/or overhead penalty. DRX induced latency may be estimated by monitoring how long data stays in the buffer and/or stalled by waiting for the next ON opportunity to transmit the data. ON slots utilization may be computed from the radio resource scheduler. ON slots may measure how effectively the network scheduler used the ON slots decided by the network agent to schedule DL data transmission to the WTRU. For example, the measurement may be based on the percentage of used ON slots. WTRU OFF time ratio may be computed from the DRX pattern decided by the network agent. WTRU OFF time may measure the amount of time the WTRU circuit was turned OFF. WTRU OFF time may measure the efficacy of the decided DRX patterns in saving the WTRU power. Overhead penalty may include the overhead associated to transmitting the DRX pattern decided by the network agent and/or the overhead associated to transmitting the WTRU DRX feedback report from the WTRU.

The network may determine a DRX pattern for the next DRX cycle based on the determined state and the computed reward. The network may monitor the learning performance of the DRX pattern by monitoring the evolution of the computed reward over the DRX cycles. The network may determine to continue learning the DRX pattern. In such a case, the network may keep updating continuously the RL policy of generating the DRX pattern from the determined state and/or reward using the configured RL algorithm.

The network may decide to stop learning the DRX pattern when the RL policy converges, (e.g., when the computed reward is higher than a certain threshold). In such a case, the network may switch the RL algorithm OFF and/or stop updating the RL policy. The network may monitor the performance of the DRX pattern against any possible drift. The network may store the reward values associated to the decided DRX patterns. If the reward is decreasing and/or is lower than a threshold, the network may switch ON the RL algorithm and/or start updating the RL policy. The network may indicate to the WTRU to stop reporting WTRU DRX feedback report.

A solution for WTRU power saving may provide dynamic and/or configurable DRX operations. Specifically, the solution may enable the network to learn DRX patterns, with the assistance of feedback from the WTRU. The network may learn the DRX patterns that better matches the WTRU traffic pattern, takes the WTRU battery state into consideration, and/or meets the service latency requirements.

As traffic patterns and/or the desired DRX patterns can be learned, AI/ML methods may be considered. The network may schedule the downlink (DL) data transmission to the WTRU during DRX cycles with configurable durations that may be either constant and/or variable. Each DRX cycle may consist of a set of time windows with configurable durations, within which the network may schedule the DL data transmission to the WTRU. Each time window may include an integer number of time slots. Simultaneously, the network may configure the ON/OFF pattern for the WTRU within each DRX cycle in a way that matches the DL data transmission scheduling pattern.

As depicted in FIG. 5, for each DRX cycle, the network may indicate to the WTRU the transmission time windows 504a-f, configured through the parameter drx-onSlot, along with the duration of each time window in time slots, configured through the parameter drx-onTime. The time slots within each time window are referred to as the ON slots. The WTRU turns ON and stays ON according to the configured drx-onSlot and/or drx-onTime parameters within each DRX cycle. A drx-cycleDuration parameter may also be sent with the DRX cycle configuration message indicating the last slot in the cycle. A drx-repetition may also be indicated. The drx-repetition may tell the WTRU how to behave until new DRX cycle parameters are received. For example, drx-repetition may indicate how many times to replicate the DRX pattern previously signaled. A drx-combine may also be indicated. The drx-combine may tell the WTRU if the indicated DRX pattern should be combined with existing DRX pattern(s) and/or should replace existing DRX pattern(s).

Such combined patterns may be useful when multiple services with different traffic patterns are required simultaneously. A drx-impliedON may also be indicated. The drx-impliedON may tell the WTRU to remain ON for the indicated number of slots following data reception in an ON Slot. A drx-impliedDC may also be indicated. The drx-impliedDC may tell the WTRU to remain ON with an indicated duty cycle for an indicated number of slots following data reception in an ON slot. For example, drx-impliedDC of 2:4:24 would indicate ON, ON, OFF, OFF, OFF, OFF pattern would repeat until 24 slots after the ON Slot in which data was received (and would be combined with any existing DRX patterns). A drx-nextDRX may also be indicated which tells the WTRU to remain OFF for the indicated number of slots between the end of DRX cycle and the beginning of the next DRX cycle.

FIG. 6 depicts a diagram of network procedures to learn a DRX pattern. FIG. 6 depicts the components of the MDP of deciding the DRX patterns by the network (e.g., gNB) 604. The network agent 608 may reside at the network scheduler 612. The network agent 608 action may be the DRX pattern. The DRX pattern may be defined in terms of the parameters drx-onSlot and the drx-onTime for each drx-onSlot. The network agent 608 may configure these parameters to the WTRU 616 over each DRX cycle. Afterwards, the radio resource scheduler 620 may allocate resources for the WTRU 616 for DL data transmission over the decided ON slots. Note that DL data transmissions may be decided solely by the radio resource scheduler 620. The radio resource scheduler 620 may decide to not schedule a DL data transmission for the WTRU 616 over an ON slot that the network agent 608 decided.

In the WTRU 616 side, the WTRU 616 may receive the DRX pattern configuration from the network 604. The WTRU 616 may turn its circuit ON/OFF based on the received DRX pattern from the network 604 for each DRX cycle. Accordingly, for each time window indicated in the drx-onSlot, the WTRU 616 may stay ON for the number of slots indicated in the associated drx-onTime. Based on this, the WTRU 616 may report ACK/NACK to the network 604. The WTRU 616 may also report its battery state information to the network 604 for effective DRX pattern decisions. The battery state and/or power saving profile information reporting may be either periodic, aperiodic, and/or semipersistent. These parameters may change slowly and so need infrequent updating. The network 604 may receive the feedback from the WTRU 616, computes the reward, and determines the new state associated to the network agent 604 actions.

The network agent reward is a combination of WTRU OFF time ratio; DRX induced latency; ON slots utilization; and/or overhead penalty. WTRU OFF time ratio may be computed from the DRX pattern decided by the network agent. WTRU OFF time ratio may measure the amount of time the WTRU circuit was turned OFF. WTRU OFF time ratio may measure efficacy of the decided DRX patterns in saving the WTRU power. DRX induced latency may be estimated by monitoring how long data stays in the buffer and/or is stalled by waiting for the next ON opportunity to transmit data. ON slots utilization may be computed from the radio resource scheduler. ON slots utilization may measure how efficiently the network scheduler used the ON slots decided by the network agent to schedule DL data transmission to the WTRU. For example, ON slots utilization can be the percentage of used ON slots. Overhead penalty may be associated to transmitting the DRX pattern decided by the network agent and to transmitting the feedback report from the WTRU. An equation for the reward may be expressed as Equation (1), but other equations may exist:

$$Reward = f ( {T}_{OFF} ) + g ( {L}_{E 2 E} ) + h ( {O}_{DRX} ) , \qquad ( 1 )$$

Where T_{OFF} denotes the WTRU OFF time ratio indicated above; L_{E2E} denotes the end-to-end latency induced by: DRX induced latency indicated above, ON slots utilization indicated above, and/or HARQ process; and/or O_{DRX} denotes the overhead penalty indicated above.

Moreover, the functions ƒ, g, and/or h may map the quantities T_{OFF}, L_{E2E}, and/or O_{DRX}, respectively, to the reward. The functions ƒ, g, and/or h may be characterized as follows: the functions ƒ, g, and/or h, are configured by the network. Each one of the functions ƒ, g, and/or h can be either preconfigured and/or learnable. Each one of the functions ƒ, g, and/or h may be polynomial (e.g., linear, quadratic, etc.), rational, AI/ML model, etc. The network may fully configure the functions g, and/or h. The network may fully configure the function ƒ, and/or the network and WTRU may jointly configure the function ƒ. Specifically, the function ƒ may map the WTRU OFF time ratio T_{OFF} to the power saved by the WTRU. Therefore, the function ƒ may provide a means to include the battery state information of the WTRU, the WTRU power profile, and/or the WTRU power saving preferences, etc., in the reward.

Consequently, for the case when the network fully configures ƒ, the WTRU may report to the network its battery state information, its power profile, its power saving preferences, and/or with any other relevant information related to the WTRU power saving mechanism and the latency-energy tradeoff requirement for the WTRU. Examples of how the WTRU may compute a power saving preference includes, but may not be limited to, battery state, estimated future use of power, and/or estimated time of recharge, etc.

For the case when the network and the WTRU jointly configure the function ƒ, the WTRU may determine a set of parameters that is part of the total set of parameters of the parametric function ƒ. The set of parameters determined by the WTRU may be associated to the WTRU battery state information, the WTRU power profile, the WTRU power saving preferences, and/or with any other relevant information related to the WTRU power saving mechanism and/or the latency-energy tradeoff requirement for the WTRU. The network may signal to the WTRU the structure of the parameters (e.g., type, format, range of parameters, etc.). The WTRU may then determine the set of parameters and then report it to the network. Then, the network may compute the entire parametric function ƒ and/or then compute the rewards.

The network agent state may comprise the history of: DRX induced latency; DL data transmission slots; buffer status; and/or WTRU battery state information. The DRX induces latency may be estimated by monitoring how long data stays in the buffer and/or stalled by waiting for the next ON opportunity to transmit it. The DL data transmission slots may be obtained from the radio resource scheduler. Buffer status may update after pushing or pulling data out for DL transmission. WTRU battery state information: may include the WTRU battery state information reported from the WTRU to the network. After the network agent computes the state and/or the reward, the network agent may decide on the DRX pattern for the next DRX cycle, and the entire procedure is repeated.

The network may use an AI/ML model for AI/ML-based DRX pattern configuration for WTRU power saving. The network may train the AI/ML model through the RL framework with the assistance of feedback from the WTRU. Particularly, the WTRU may transmit the WTRU DRX feedback report to the network based on the received WTRU DRX feedback report configuration. Then, the network may determine the state and the reward with the assistance of the WTRU DRX feedback report transmitted by the WTRU. The stages of the AI/ML process (e.g., the RL framework) are described herein:

Application: the application of the process involves DRX pattern configuration for WTRU power saving.

Agent: the RL agent may learn about a problem by interacting with its environment. Through trial and error, the RL agents may learn to act and/or to execute tasks. The RL agent may learn from rewards and/or penalties to take actions within the environment that meet a predefined goal (e.g., DRX pattern configuration for WTRU power saving). In the proposed solution, the RL agent may be located at the network to decide on the DRX pattern for the next DRX cycle through the determined state and the computed reward.

State: the state regards the situation of the environment that the RL agent considers while taking an action. For the DRX pattern configuration for WTRU power saving, the state may include, but not be limited to: history of DRX Induced latency; history of DL data transmission slots; buffer status; and/or WTRU battery state information. History of DRX induced latency may be estimated by monitoring how long data stays in the buffer and/or stalled by waiting for the next ON opportunity to transmit the data. History of DL data transmission slots may be obtained from the radio resource scheduler. Buffer status may be updated after pushing and/or pulling data out for DL transmission. WTRU battery state information may be obtained from the WTRU DRX feedback report transmitted from the WTRU to the network.

Reward: the network agent reward for the DRX pattern configuration for WTRU power saving may be a combination of: DRX induced latency; ON slots utilization; WTRU OFF time ratio; and/or overhead penalty. DRX induced latency may be estimated by monitoring how long data stays in the buffer and/or stalled by waiting for the next ON opportunity to transmit the data. ON slots utilization may be computed from the radio resource scheduler. ON slots may measure how effectively the network scheduler used the ON slots decided by the network agent to schedule DL data transmission to the WTRU. For example, the measurement may be based on the percentage of used ON slots. WTRU OFF time ratio may be computed from the DRX pattern decided by the network agent. WTRU OFF time may measure the amount of time the WTRU circuit was turned OFF. WTRU OFF time may measure the efficacy of the decided DRX patterns in saving the WTRU power. Overhead penalty may include the overhead associated to transmitting the DRX pattern decided by the network agent and/or the overhead associated to transmitting the WTRU DRX feedback report from the WTRU.

RL Algorithm: the agent in the RL algorithm may contain two main components: the policy and the learning algorithm. The policy (e.g., actor) may be a mapping from the current state to a probability distribution of the actions to be taken. Within an agent, a function approximator may implement the policy with tunable parameters and/or a specific approximation model, such as neural networks. Learning Algorithm (e.g., value function) may continuously update the policy parameters based on the actions, states, and/or rewards. The goal of the learning algorithm is to find an optimal policy that maximizes the expected cumulative long-term reward. The policy search techniques may target finding the policies through gradient-free and/or gradient-based methods. The examples of policy search methods include actor-critic, deep deterministic policy gradients (DDPG), and/or trust region policy optimization (TRPO), etc.

Training: the network may perform the training through RL framework with the assistance of WTRU feedback (e.g., WTRU DRX feedback report) as explained in the proposed solution in this disclosure.

When a WTRU is configured with dynamic DRX operations, the network may configure key parameters. These key parameters may include the DRX pattern configuration; radio resource allocations; and WTRU DRX feedback report configuration.

For the DRX pattern configuration, the WTRU may receive the DRX pattern configuration at the beginning of each DRX cycle. The WTRU may receive the DRX pattern configuration dynamically (e.g., through DCI and/or MAC-CE).

For the radio resource allocations, the WTRU may only receive the radio resource allocations during each ON slot in each DRX cycle. The WTRU may receive the radio resource allocations dynamically (e.g., through DCI and/or MAC-CE).

The WTRU DRX feedback report configuration may include, but not be limited to, the messages and parameters that should be included in the WTRU DRX feedback report, which include, but may not limited to: WTRU battery state information and/or information to compute the reward of the RL-framework at the network. If the network fully computes the reward, the WTRU DRX feedback report may include the WTRU battery state information, the WTRU power profile, the WTRU power saving preferences, and/or with any other relevant information related to the WTRU power saving mechanism and/or to the latency-energy tradeoff requirement for the WTRU. If the network and the WTRU jointly compute the network and the WTRU, the WTRU DRX feedback report may include a set of parameters that is part of the network reward function. The set of parameters may be associated to the WTRU battery state information, the WTRU power profile, the WTRU power saving preferences, and/or any other relevant information related to the WTRU power saving mechanism and to the latency-energy tradeoff requirement for the WTRU. The structure of the parameters (e.g., type, format, range of parameters, etc.) may be either preconfigured or dynamically configured by the network.

The WTRU DRX feedback report configuration may include the mechanism to transmit the WTRU DRX feedback report. Examples may include time-based feedback reporting, wherein the WTRU DRX feedback report may be periodic, aperiodic, or semi-persistent. Examples may further include event-triggered feedback reporting wherein the WTRU may compute a certain parameter associated to the reward of the RL framework at the network. The WTRU may compare the computed parameter to some thresholds configured by the network. The WTRU may transmit the WTRU DRX feedback report if the computed parameter is lower or higher than the configured thresholds. The mechanism may be a mixture of time-based feedback reporting and/or event-triggered feedback reporting. The WTRU DRX feedback report configuration may include the signals and/or the uplink resource configuration and/or allocations that should carry the WTRU DRX feedback report.

The WTRU DRX feedback report configuration may be either preconfigured, configured by means of RRC signaling, and/or dynamically configured (e.g., through DCI and/or MAC-CE).

For dynamic DRX operations, signaling may be defined by a DRX feedback report. The WTRU DRX feedback report may include but not be limited to: WTRU battery state information and/or information to compute the reward of the RL-framework at the network. If the network fully computes the reward, the WTRU DRX feedback report may include the WTRU battery state information, the WTRU power profile, the WTRU power saving preferences, and/or with any other relevant information related to the WTRU power saving mechanism and/or to the latency-energy tradeoff requirement for the WTRU. If the network and the WTRU jointly compute the network and the WTRU, the WTRU DRX feedback report may include a set of parameters that is part of the network reward function. The set of parameters may be associated to the WTRU battery state information, the WTRU power profile, the WTRU power saving preferences, and/or any other relevant information related to the WTRU power saving mechanism and to the latency-energy tradeoff requirement for the WTRU. The structure of the parameters (e.g., type, format, range of parameters, etc.) may be either preconfigured or dynamically configured by the network.

FIG. 7 depicts a flowchart 700 that details the WTRU procedures for dynamic DRX operation. The network may refer to any node in the network (e.g., gNB), and/or another WTRU (e.g., sidelink, WTRU-to-WTRU direct communication), etc. At 704, the WTRU may receive (e.g., from the network) a request to transmit dynamic DRX operation capabilities. At 708, the WTRU may transmit its capabilities to the network by means of RRC signaling. The WTRU may transmit a capabilities message indicating WTRU support for dynamic DRX operation.

At 712, the WTRU is configured with a DRX pattern. The DRX pattern may include: the DRX cycle duration drx-cycleDuration. If not included, the last ON slot may imply the end of the cycle. The DRX pattern may include the time windows, which include the ON Slots within the DRX cycle, defined with the parameter drx-onSlot. The DRX pattern may include the duration of each time window in time slots, defined by the parameter drx-onTime. The DRX pattern may include other parameters, such as drx-repetition, drx-combine, drx-impliedON, drx-impliedDC, drx-nextDRX, etc. The DRX pattern may include the start of the next DRX cycle. The initial DRX pattern may be generated from legacy DRX patterns. The WTRU may receive the DRX pattern configuration at the beginning of each DRX cycle. The WTRU may receive the DRX pattern configuration dynamically (e.g., through DCI and/or MAC-CE).

At 716, the WTRU may be configured with resources for DL data transmission. The radio resources may occur during any ON slot in each DRX cycle. The WTRU may receive the radio resource allocations dynamically (e.g., through DCI and/or MAC-CE).

At 720, the WTRU may receive configuration (e.g., from the network) of the WTRU DRX feedback report configuration. The WTRU DRX feedback report configuration may include one or more of the messages and/or parameters that should be included in the WTRU DRX feedback report, which include one or more of: WTRU battery state information and/or information to compute the reward of the RL-framework at the network. If the network fully computes the reward, then the WTRU DRX feedback report may include the WTRU battery state information, the WTRU power profile, the WTRU power saving preferences, and/or with any other relevant information related to the WTRU power saving mechanism and/or to the latency-energy tradeoff requirement for the WTRU. If the network and WTRU jointly compute the reward, the WTRU DRX feedback report may include a set of parameters that is part of the network reward function. Moreover, the set of parameters may be associated to the WTRU battery state information, the WTRU power profile, the WTRU power saving preferences, and/or any other relevant information related to the WTRU power saving mechanism and to the latency-energy tradeoff requirement for the WTRU. The structure of the parameters (e.g., type, format, range of parameters, etc.) may be either preconfigured and/or dynamically configured by the network.

The WTRU feedback report configuration may further include the reporting condition (e.g., triggering condition) of a transmission of the WTRU DRX feedback report. Examples may include time-based feedback reporting condition, wherein the WTRU DRX feedback report may be periodic, aperiodic, or semi-persistent. Examples may further include event-triggered feedback reporting condition wherein the WTRU may compute a certain parameter associated to the reward of the RL framework at the network. The WTRU may compare the computed parameter to some thresholds configured by the network. The WTRU may transmit the WTRU DRX feedback report if the computed parameter is lower or higher than the configured thresholds. The reporting condition of a transmission of the WTRU DRX feedback report may further include a mixture of time-based feedback reporting condition and event-triggered feedback reporting condition and/or a request from the network.

The WTRU feedback report configuration may further include the signals and/or the uplink resource configuration/allocations that should carry the WTRU DRX feedback report. For example, PUSCH, PUCCH, RRC, UCI, and/or MAC-CE. For example, a WTRU may report WTRU DRX feedback report in a HARQ-ACK report (e.g., appended to or multiplexed with a HARQ-ACK report). The WTRU DRX feedback report configuration may be either preconfigured, configured by means of RRC signaling, or dynamically configured (e.g., through DCI or MAC-CE).

At 724, the WTRU may turn ON within each DRX cycle according to the received DRX pattern configuration. At 728, the WTRU may transmit the WTRU DRX feedback report to the network based on the configured reporting condition. The WTRU may transmit the WTRU DRX feedback report. The WTRU may transmit the WTRU DRX feedback report in the UCI, transmitted on PUCCH and/or PUSCH.

The network may receive the WTRU DRX feedback report from the WTRU. The network may determine the state and/or the reward with the assistance of the WTRU DRX feedback report transmitted by the WTRU. The state may include, but not be limited to: history of DRX Induced latency; history of DL data transmission slots; buffer status; and/or WTRU battery state information. History of DRX induced latency may be estimated by monitoring how long data stays in the buffer and/or stalled by waiting for the next ON opportunity to transmit the data. History of DL data transmission slots may be obtained from the radio resource scheduler. Buffer status may be updated after pushing and/or pulling data out for DL transmission. WTRU battery state information may be obtained from the WTRU DRX feedback report transmitted from the WTRU to the network. The reward may be a combination of: DRX induced latency; ON slots utilization; WTRU OFF time ratio; and/or overhead penalty. DRX induced latency may be estimated by monitoring how long data stays in the buffer and/or stalled by waiting for the next ON opportunity to transmit the data. ON slots utilization may be computed from the radio resource scheduler. ON slots may measure how effectively the network scheduler used the ON slots decided by the network agent to schedule DL data transmission to the WTRU. For example, the measurement may be based on the percentage of used ON slots. WTRU OFF time ratio may be computed from the DRX pattern decided by the network agent. WTRU OFF time may measure the amount of time the WTRU circuit was turned OFF. WTRU OFF time may measure the efficacy of the decided DRX patterns in saving the WTRU power. Overhead penalty may include the overhead associated to transmitting the DRX pattern decided by the network agent and/or the overhead associated to transmitting the WTRU DRX feedback report from the WTRU.

The network may determine a DRX pattern, for the next DRX cycle based on the determined state and the computed reward. The network may monitor the learning performance of the DRX pattern by monitoring the evolution of the computed reward over the DRX cycles. The network may determine to continue learning the DRX pattern. In such a case, the network may keep updating continuously the RL policy of generating the DRX pattern from the determined state and/or reward using the configured RL algorithm.

The network may decide to stop learning the DRX pattern when the RL policy converges, (e.g., when the computed reward is higher than a certain threshold). In such a case, the network may switch the RL algorithm OFF and/or stop updating the RL policy. The network may monitor the performance of the DRX pattern against any possible drift. The network may store the reward values associated to the decided DRX patterns. If the reward is decreasing and/or is lower than a threshold, the network may switch ON the RL algorithm and/or start updating the RL policy. The network may indicate to the WTRU to stop reporting WTRU DRX feedback report.

What is claimed is:

1. A wireless transmit/receive unit (WTRU) comprising:
a processor and memory, the processor and memory configured to:
receive first configuration information, the first configuration information indicating a discontinuous reception (DRX) pattern;
receive second configuration information, the second configuration information comprising one or more of parameters associated with a DRX feedback report, a reporting condition for transmitting the DRX feedback report, and uplink (UL) resource configurations for carrying the DRX feedback report; and
transmit the DRX feedback report based on the reporting condition, wherein the DRX feedback report comprises one or more of WTRU battery state information or information associated with a calculation of a reward used in a reinforcement learning model at the network to determine the DRX pattern.

2. The WTRU of claim 1, wherein the DRX pattern further comprises a DRX cycle duration, one or more time windows designating when the WTRU turns on during a DRX cycle, the duration of each time window, and the start of the next DRX cycle.

3. The WTRU of claim 1, wherein the reward is computed by the network, and wherein the information associated with the calculation of the reward comprises one or more of an indication of a power saving preference of the WTRU, a power profile of the WTRU, or an estimated time-to-recharge of the WTRU.

4. The WTRU of claim 1, wherein the reward is computed by the network and the WTRU, and wherein the information associated with the calculation of the reward comprises a set of parameters associated with a reward function.

5. The WTRU of claim 1, wherein the reporting condition for transmitting the DRX feedback report is an event-triggered feedback reporting condition. Reporting is triggered based on a comparison of a parameter associated with a reward for a reinforcement learning model at the network to a threshold.

6. The WTRU of claim 1, wherein the reporting condition for transmitting is the DRX feedback report is associated with time-based feedback reporting, wherein the time-based feedback reporting indicates periodic, aperiodic, or semi-persistent transmission of the DRX feedback report.

7. The WTRU of claim 1, wherein the processor is further configured to:
receive a request to transmit dynamic DRX operation capabilities; and
transmit a response message, the response message comprising the WTRU's dynamic DRX operation capabilities.

8. The WTRU of claim 1, wherein the processor is further configured to receive an updated DRX pattern, wherein the updated DRX pattern is different than the DRX pattern indicated by the first configuration information and is based on the DRX feedback report.

9. The WTRU of claim 1, wherein the processor is further configured to transmit the DRX feedback report in a hybrid automatic repeat request (HARQ) acknowledgement/not acknowledgement (ACK/NACK) report.

10. The WTRU of claim 1, wherein the processor is further configured to transmit the DRX feedback report in the uplink (UL) control information and on the physical UL control channel (PUCCH) or physical UL shared channel (PUSCH).

11. A method implemented by a wireless transmit/receive unit (WTRU), the method comprising:
receiving first configuration information, the first configuration information indicating a discontinuous reception (DRX) pattern;
receiving second configuration information, the second configuration information comprising one or more of parameters associated with a DRX feedback report, a reporting condition for transmitting the DRX feedback report, and uplink (UL) resource configurations for carrying the DRX feedback report; and
transmitting the DRX feedback report based on the reporting condition being satisfied, wherein the DRX feedback report comprises one or more of WTRU battery state information or information associated with a calculation of a reward used in a reinforcement learning model at the network to determine the DRX pattern.

12. The method of claim 11, wherein the DRX pattern further comprises a DRX cycle duration, time windows designating when the WTRU turns on during a DRX cycle, the duration of each time window, and the start of the next DRX cycle.

13. The method of claim 11, wherein the reward is computed by the network, and wherein the information associated with the calculation of the reward comprises one or more of an indication of a power saving preference of the WTRU or a power profile of the WTRU, or an estimated time-to-recharge of the WTRU.

14. The method of claim 11, wherein the reward is computed by the network and the WTRU, and wherein the information associated with the calculation of the reward comprises a set of parameters associated with a reward function.

15. The method of claim 11, wherein the reporting condition for transmitting the DRX feedback report is an event-triggered feedback reporting condition. Reporting is triggered based on a comparison of a parameter associated with a reward for a reinforcement learning model to a threshold.

16. The method of claim 11, wherein the reporting condition for transmitting is the DRX feedback report is associated with time-based feedback reporting, wherein the time-based feedback reporting indicates periodic, aperiodic, or semi-persistent transmission of the DRX feedback report.

17. The method of claim 11, further comprising:
receiving a request to transmit dynamic DRX operation capabilities; and
transmitting a response message, the response message comprising the WTRU's dynamic DRX operation capabilities.

18. The method of claim 11, further comprising:
receiving an updated DRX pattern, wherein the updated DRX pattern is different than the DRX pattern indicated by the first configuration information and is based on the DRX feedback report.

19. The method of claim 11, further comprising transmitting the DRX feedback report in a hybrid automatic repeat request (HARQ) acknowledgement/not acknowledgement (ACK/NACK) report.

20. The method of claim 11, further comprising transmitting the DRX feedback report in the uplink (UL) control information and on the physical UL control channel (PUCCH) or physical UL shared channel (PUSCH).
